(19) United States
(12) Patent Application Publication
(10) Pub. No.: US 2021/0302641 A1
(43) Pub. Date: Sep. 30, 2021

(54) POLARIZING LAMINATE AND IMAGE DISPLAY DEVICE INCLUDING THE SAME

(71) Applicant: DONGWOO FINE-CHEM CO., LTD., Jeollabuk-do (KR)

(72) Inventors: Min Seok KIM, Gyeonggi-do (KR); Jeong Eun LEE, Gyeonggi-do (KR)

(21) Appl. No.: 17/215,380

(22) Filed: Mar. 29, 2021

(30) Foreign Application Priority Data
Mar. 31, 2020 (KR) 10-2020-0039140

(51) Int. Cl. G02B 5/30; G02F 1/1335; G02F 1/1333

(52) U.S. Cl. CPC G02B 5/3091; G02F 1/13338; G02F 1/133528

(57) ABSTRACT

A polarizing laminate according to an embodiments of the present invention includes a polarizer, a retardation layer disposed on one surface of the polarizer, and a protective layer disposed on the other surface of the polarizer and having a coefficient of thermal expansion of 60 μm/m·° C. or less. Thereby, flexibility and antireflection performance may be improve.

### CROSS-REFERENCE TO RELATED APPLICATION AND CLAIM OF PRIORITY

This application claims priority to Korean Patent Applications No. 10-2020-0039140 filed on Mar. 31, 2020 in the Korean Intellectual Property Office (KIPO), the entire disclosure of which is incorporated by reference herein.

### BACKGROUND

### 1. Technical Field

The present invention relates to a polarizing laminate and an image display device including the same.

### 2. Background Art

Recently, according to development of the information-oriented society, needs for a display field have also been presented in various forms. For example, a liquid crystal display device, a plasma display panel device, an electroluminescent display device, an organic light-emitting diode display device, etc., which have characteristics such as a slimness, weight reduction, and low power consumption, etc., have been studied.

The display device has a problem that, when external light exists, the external light is reflected or scattered from an image display surface of the display device, such that an original image displayed on the display device is not viewed well. Accordingly, an optical film including a retardation film and a polarizer may be coupled to the display device to improve video or image quality.

According to development of flexible, foldable, and rollable display devices, improving flexibility of the optical film applied thereto is required.

To this end, for example, Korean Patent Laid-Open Publication No. 10-2013-0110204 discloses a polarizing plate for implementing an image with a high contrast, but it does not secure a flexibility to an extend of suitable for the flexible display device.

### SUMMARY

Accordingly, an object of the present invention is to provide a polarizing laminate having excellent flexibility and antireflection performance.

Another object of the present invention is to provide an image display device having excellent flexibility and antireflection performance.

To achieve the above objects, the following technical solutions are adopted in the present invention.

1. A polarizing laminate including: a polarizer having a first surface and a second surface opposite to the first surface; a retardation layer disposed on the first surface of the polarizer; and a protective layer disposed on the second surface of the polarizer and having a coefficient of thermal expansion of 60 μm/m·° C. or less.

2. The polarizing laminate according to the above 1, wherein the retardation layer includes a quarter-wave retardation film.

3. The polarizing laminate according to the above 1, wherein the protective layer has a thickness of 10 to 20 μm.

4. The polarizing laminate according to the above 1, wherein the polarizing laminate has a thickness of 30 to 40 μm.

5. The polarizing laminate according to the above 1, wherein the protective layer has a coefficient of thermal expansion of 40 μm/m·° C. to 60 μm/m·° C.

6. The polarizing laminate according to the above 1, wherein the protective layer has a near-ultraviolet transmittance of 3% or less.

7. The polarizing laminate according to the above 1, wherein the protective layer has a breaking strength of 20 to 30 N/25 mm.

8. The polarizing laminate according to the above 1, wherein the protective layer has a storage modulus of 1,900 to 2,100 MPa.

9. An image display device including the polarizing laminate according to the above 1.

10. The image display device according to the above 9, wherein the image display device is a flexible image display device.

11. The image display device according to the above 10, further including a window substrate, a touch sensor, and a display panel.

According to embodiments of the present invention, when the protective layer having a predetermined coefficient of thermal expansion is laminated together with the polarizer and the retardation layer, external light reflection characteristics may be implemented and folding properties may be improved.

In addition, when the retardation layer includes the quarter-wave retardation film and a half-wave retardation film, color interference due to the polarizing laminate is suppressed, such that vivid colors may be implemented.

Further, when the retardation layer is adhered to the polarizer by a pressure-sensitive adhesive layer directly formed thereon, the protective film under the polarizer may be omitted. Therefore, a thickness of the polarizing laminate may be reduced and the flexibility may be improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view illustrating a polarizing laminate according to exemplary embodiments;

FIG. 2 is a schematic cross-sectional view illustrating a polarizing laminate according to exemplary embodiments;

FIG. 3 is a schematic view illustrating a traveling pattern of light passing through the polarizing laminate according to exemplary embodiments;

FIG. 4 is a schematic cross-sectional view illustrating an image display device according to exemplary embodiments;

FIG. 5 is a schematic cross-sectional view illustrating an image display device according to exemplary embodiments; and

FIG. 6 is a schematic view illustrating a method for evaluating folding properties of the polarizing laminate.

### DETAILED DESCRIPTION

Embodiments of the present invention provide a polarizing laminate in which a polarizer, a retardation layer, and a protective layer having a predetermined coefficient of thermal expansion are laminated. The polarizing laminate may have excellent flexibility and antireflection performance.

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

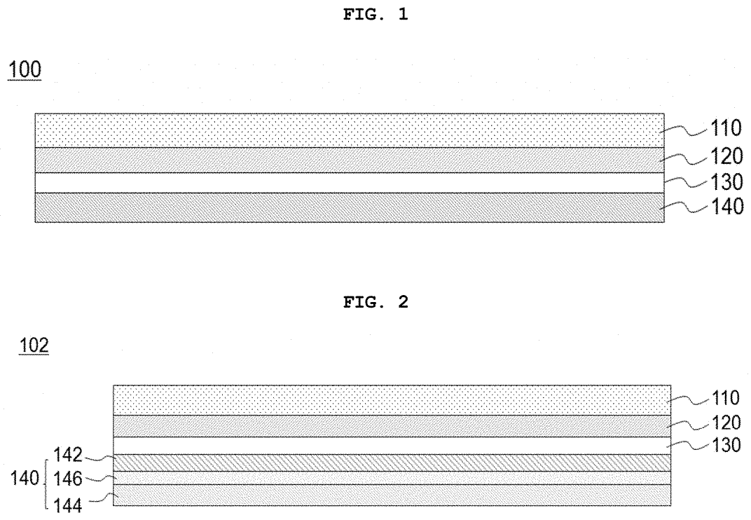

FIG. 1 is a schematic cross-sectional view illustrating a polarizing laminate according to exemplary embodiments.

Referring to FIG. 1, a polarizing laminate 100 may include a protective layer 110, a polarizer 120, a pressure-sensitive adhesive layer 130, and a retardation layer 140.

The polarizer 120 may be, for example, a film in which a dichroic dye is adsorbed and oriented on an elongated polyvinyl alcohol resin film. The polyvinyl alcohol resin may be obtained by saponification of a polyvinyl acetate resin.

Examples of the polyvinyl acetate resin may include polyvinyl acetate which is a homopolymer of vinyl acetate, or a copolymer of vinyl acetate and any other monomer copolymerizable therewith. Examples of other monomers copolymerizable with the vinyl acetate may include unsaturated carboxylic acid, unsaturated sulfonic acid, olefin, vinyl ether, and ammonium group-containing acrylamide monomers, etc.

The polyvinyl alcohol resin may include modified resin, and for example, aldehyde-modified polyvinyl formal, polyvinyl acetal, and the like may be used. A degree of saponification of the polyvinyl alcohol resin may be 85 to 100 mol %, and preferably 98 mol % or more. The degree of saponification of the polyvinyl alcohol resin may be about 1,000 to 10,000, and preferably 1,500 to 5,000.

The above-described polyvinyl alcohol resin film may be used as a raw film of the polarizer 120. The raw film may have a film thickness of 10 to 150 μm, for example.

In some embodiments, the polarizer 120 may be fabricated by a series of processes including: continuously performing mono-axial elongation of a polyvinyl alcohol film in an aqueous solution; dyeing with a dichroic dye to adsorb the same; performing treatment using a boric acid solution; then washing and drying the same, etc.

The protective layer 110 may be formed on at least one surface of the polarizer 120. For example, the protective layer 110 may be directly disposed on one surface of the polarizer 120.

The protective layer 110 may include a resin film having excellent properties such as transparency, mechanical strength, thermal stability, moisture-shielding properties, and isotropic properties. For example, the protective layer 110 may include acryl resin films such as polymethyl(meth)acrylate, polyethyl(meth)acrylate, etc.; polyester resin films such as polyethylene terephthalate, polyethylene isophthalate, polyethylene naphthalate, polybutylene terephthalate, etc.; cellulose resin films such as diacetyl cellulose, triacetyl cellulose, etc.; polyolefin resin films such as polyethylene, polypropylene, polyolefin having a cyclo or norbornene structure, ethylene-propylene copolymer, etc.

Preferably, the protective layer 110 may include a cyclopolyolefin (COP) resin film. In this case, mechanical strength and heat resistance may be improved. A cycloolefin resin film may include a cycloolefin polymer. The cycloolefin polymer may have a cycloalkane structure in a main chain and/or a side chain.

The cycloalkane structure may include a monocyclic structure or a polycyclic structure such as a condensed polycyclic or cross-linked cyclic structure. One unit of the cycloalkane structure may have 4 to 30 carbon atoms. Preferably, one unit of the cycloalkane structure includes 5 to 15 carbon atoms.

A ratio of a repeating unit having the cycloalkane structure in the cycloolefin polymer is preferably 55% by weight (‘wt. %’) or more, more preferably 70 wt. % or more, and particularly preferably 90 wt. % or more. In this case, transparency and heat resistance may be improved.

The cycloolefin polymer may include a norbornene resin, monocyclic olefin resin, cyclic conjugated diene resin, vinyl alicyclic hydrocarbon resin, and hydrides thereof. Preferably, the norbornene resin is used in terms of transparency and moldability.

Examples of the norbornene resin may include a ring-opening polymer of a monomer having a norbornene structure, a ring-opening copolymer of a monomer having a norbornene structure and another monomer, or hydrides thereof; an addition polymer of a monomer having a norbornene structure, an addition copolymer of a monomer having a norbornene structure and another monomer, or hydrides thereof. Preferably, a ring-opening (co)polymer hydride of a monomer having a norbornene structure is used in terms of transparency, moldability, heat resistance, low hygroscopic property, dimensional stability, and lightweightness, etc.

The monomer having a norbornene structure may include bicyclo[2.2.1]hepto-2-ene (common name: norbornene), tricyclo[4.3.0.12,5]deca-3,7-diene (common name: dicyclopenta diene), 7,8-benzotricyclo[4.3.0.12,5]deca-3-ene (common name: methanotetrahydrofluorene), tetracyclo[4.4.0.12,5.17,10]dodeca-3-ene (common name: tracyclododecene) and derivatives thereof and the like. The derivative may include, for example, a compound substituted with a substituent such as an alkyl group, alkylene group, polar group and the like. The monomer having a norbornene structure may be used alone or in combination of two or more thereof.

The polar group may include a carboxyl group, carbonyloxycarbonyl group, epoxy group, hydroxyl group, oxy group, ester group, silanol group, silyl group, amino group, nitrile group, sulfone group and the like.

Other monomers which are ring-opening copolymerizable with a monomer having a norbornene structure may include monocyclic olefins such as cyclohexene, cycloheptene, and cyclooctene, etc., and derivatives thereof; and cyclic conjugated dienes such as cyclohexadiene and cycloheptadiene, etc., and derivatives thereof.

A ring-opening copolymer of a ring-opening polymer of the ring-opening polymer of a monomer having a norbornene structure and another monomer copolymerizable with the monomer having a norbornene structure may be obtained by polymerizing the monomers in the presence of known ring-opening polymerization catalysts.

Other monomers which are additionally copolymerizable with the monomer having a norbornene structure may include, for example, α-olefin having 2 to 20 carbon atoms such as ethylene, propylene, and 1-butene, and derivatives thereof; cycloolefin such as cyclobutene, cyclopentene, cyclohexene, etc., and derivatives thereof; and non-conjugated diene such as 1,4-hexadiene, 4-methyl-1,4-hexadiene, 5-methyl-1,4-hexadiene and the like. These monomers may be used alone or in combination of two or more thereof. Among these, α-olefin is preferably used and ethylene is more preferably used.

An addition copolymer of an addition polymer of a monomer having a norbornene structure and another monomer copolymerizable with the monomer having a norbornene structure may be obtained by polymerizing the monomers in the presence of known addition polymerization catalysts.

The hydride of the (co)polymers may be obtained by adding known hydrogenation catalysts containing transition metal such as nickel or palladium to a solution of the (co)polymer to contact hydrogen, thereby allowing 90% or more of carbon-carbon unsaturated bond to be hydrogenated.

The cycloolefin polymer may have a weight average molecular weight (Mw) of 10,000 to 100,000, preferably 15,000 to 80,000, and more preferably 20,000 to 50,000, but it is not limited thereto. In this case, the mechanical strength and moldability of the film may be improved.

The resin included in the resin film may have a glass transition temperature of 80° C. or higher, and preferably 100 to 250° C.

In exemplary embodiments, the protective layer 110 may be formed in a known drawing process by drawing a non-elongated film obtained by known molding processes such as a casting molding, extrusion molding, or inflation molding process.

The non-elongated film may be a single layer film or a laminated film. The laminated film may be obtained by known processes such as a coextrusion molding, film lamination, and coating process. Among these, the coextrusion molding process is preferably used.

The drawing process may include an oblique drawing process.

In the oblique drawing process, for example, the non-elongated film may be elongated in an oblique direction using a tenter drawing machine. In the oblique drawing process, the non-elongated film may be obliquely elongated with a tenter drawing machine in which a rail layout is inclined by 40° to 50° with respect to a roll-to-roll winding direction (machine direction (MD)).

A drawing ratio in the drawing process may be 1.3 to 3.0 times, and preferably 1.5 to 2.5 times of the original size. In this case, a uniform thickness may be formed in a width direction.

In exemplary embodiments, the protective layer 110 may have a coefficient of thermal expansion (CTE) of 60 μm/m·° C. or less. When the coefficient of thermal expansion exceeds 60 μm/m·° C., folding properties of the polarizing laminate 100 may be deteriorated.

As used herein, the term “coefficient of thermal expansion” may refer to an amount of change in an average length of a sample with respect to a unit temperature (1° C.) measured while increasing the temperature of a protective layer sample from 30° C. to 100° C.

In some embodiments, the protective layer 110 may have a coefficient of thermal expansion of 40 μm/m·° C. or more. When the coefficient of thermal expansion is less than 40 μm/m ° C., an expansion stress is applied to the retardation layer 140 by the protective layer 110 during bending, such that deformation or crack may occur in the retardation layer 140.

In exemplary embodiments, the protective layer 110 may have a thickness of 10 to 20 μm. When the thickness thereof is less than 10 μm, the mechanical strength of the protective layer 110 is decreased, such that protective performance for the polarizer 120 may be reduced. When the thickness thereof exceeds 20 μm, the folding properties of the polarizing laminate 100 may be deteriorated.

In exemplary embodiments, the protective layer 110 may have a near-ultraviolet transmittance of 3% or less. When the near-ultraviolet transmittance of the protective layer 110 is adjusted to 3% or less by controlling the thickness and elongation, display elements (e.g., blue OLED elements) disposed under the polarizing laminate 100 may be protected. Preferably, the protective layer 110 has a near-ultraviolet transmittance of 1% or less.

In some embodiments, the protective layer 110 may have a breaking strength of 20 to 30N/25 mm. When the breaking strength thereof is less than 20N/25 mm, breakage of the protective layer 110 may occur during bending. When the breaking strength thereof exceeds 30N/25 mm, entire flexibility of the polarizing laminate 100 may be decreased as the strength of the protective layer 110 is increased. The breaking strength may mean, for example, a breaking strength in a direction in which the protective layer 110 moves, i.e., the machine direction (MD) or a traverse direction (TD) perpendicular to the MD in the roll-to-roll process in which the polarizing laminate is manufactured.

In some embodiments, the protective layer 110 may have a storage modulus of 1,900 to 2,100 MPa. When the protective layer 110 has the storage modulus satisfying the above-described range while having the coefficient of thermal expansion, near-infrared transmittance, breaking strength, or thickness within the above-described range, it is possible to effectively maintain adhesion with the polarizer 120 and effectively prevent the polarizer 120 from being cracked and peeled-off during bending. The storage modulus may mean a storage modulus of the protective layer 110 in the machine direction (MD).

In some embodiments, the protective layer 110 may be formed on only one surface of the polarizer 120, and the protective layer may not be formed on the other surface of the polarizer 120. In this case, compared to the case of forming polarizer protective films having a relatively strong hardness on both sides of the polarizer 120, it is possible to prevent the polarizer 120 from being broken (cracked) by a stress applied from the polarizer protective films formed on both sides during bending, or the polarizer 120 and the pressure-sensitive adhesive layer 130 and/or the retardation layer 140 from being peeled-off. In addition, it is possible to prevent an occurrence of a crack in the retardation layer 140 by preventing the retardation layer 140 from being applied with a stress by a lower polarizer protective film during bending.

In some embodiments, the protective layer 110 may be attached to the polarizer 120 through a pressure-sensitive adhesive.

For example, the pressure-sensitive adhesive may include a photocurable pressure-sensitive adhesive composition. The photocurable pressure-sensitive adhesive composition is applied to an adhesive surface of the polarizer 120 or the protective layer 110 to adhere with each other, then the polarizer 120 and the protective layer 110 may be adhered to each other by cross-linking the pressure-sensitive adhesive composition through an exposure process.

The photocurable pressure-sensitive adhesive composition may include a photo-polymerizable compound, a photo-polymerization initiator and a solvent.

The photo-polymerizable compound may include a photo-radical polymerizable compound or a photo-cationic polymerizable compound. Preferably, the photo-radical polymerizable compound or the photo-cationic polymerizable compound may be used together therewith.

The photo-polymerization initiator may be, for example, an acetophenone, benzophenone, thioxanthone, benzoin or benzoinalkylether photo-radical polymerization initiator; and/or a photo-cationic polymerization initiator such as an aromatic diazonium salt, aromatic sulfonium salt, aromatic iodine aluminum salt, benzoin sulfonic acid ester compound and the like.

In order to improve adhesion through the pressure-sensitive adhesive, primer treatment, plasma treatment, corona treatment, and saponification (alkalization) surface treatment may be performed on the adhesion surface of the polarizer 120 and/or the protective layer 110.

In some embodiments, the protective layer 110 may be formed directly on one surface of the polarizer 120. In this case, the thickness of the polarizing laminate 100 may be reduced and the flexibility may be increased.

The retardation layer 140 may be formed on the other surface of the polarizer 120. The retardation layer 140 may emit light incident thereon by delaying a phase with respect to a component vibrating in a slow axis direction. Accordingly, reflection of light incident from an outside may be suppressed.

The retardation layer 140 may include, for example, a quarter-wave retardation film. For example, a quarter-wave retardation film 144 may emit the incident light by delaying a phase by ¼ λ with respect to the component vibrating in the slow axis direction. The slow axis of the quarter-wave retardation film may form an angle of 40 to 50°, for example 45°, with respect to an absorption axis of the polarizer 120.

Thereby, light polarized by the polarizer 120 may be converted into circularly polarized light. The circularly polarized light may be reflected, such that a rotation direction thereof may be reversed. The reversed circularly polarized light may be converted into polarized light having a polarization axis of about 90° with respect to a polarization axis of the incident polarized light while passing through the quarter-wave retardation film 144 again. The converted polarized light may be blocked by the polarizer 120. Accordingly, external light reflection characteristics may be implemented by the polarizing laminate 100.

The term “slow axis” as used herein may refer to an optical axis in which a phase delay or phase difference occurs when light passes through a film.

In some embodiments, the retardation layer 140 may be adhered to the polarizer 120 by the pressure-sensitive adhesive layer 130.

The pressure-sensitive adhesive layer 130 may be formed of the above-described photocurable pressure-sensitive adhesive.

In exemplary embodiments, the pressure-sensitive adhesive layer 130 may directly contact one surface of the polarizer 120 and an upper surface of the retardation layer 140. In this case, an additional layer such as a polarizer protective film may be omitted between the polarizer 120 and the retardation layer 140. Accordingly, the thickness of the polarizing laminate 100 may be reduced and the folding properties may be improved.

FIG. 2 is a schematic cross-sectional view illustrating a polarizing laminate according to exemplary embodiments.

Referring to FIG. 2, the retardation layer 140 of the polarizing laminate 102 may include a half-wave retardation film 142 and a quarter-wave retardation film 144.

The half-wave retardation film 142 and the quarter-wave retardation film 144 may be sequentially disposed from the polarizer 120, but it is not limited thereto.

The half-wave retardation film 142 and the quarter-wave retardation film 144 may have reverse wavelength dispersion characteristics, flat wavelength dispersion characteristics, normal wavelength dispersion characteristics.

The half-wave retardation film 142 and the quarter-wave retardation film 144 may be formed in a film type or a liquid crystal coating layer type retardation film.

The film-type retardation film may be obtained, for example, by orienting a polymer film of the present invention in a mono-axial direction, bi-axial direction, or other suitable methods known in the art. For example, the polymer film may include a cyclic polymer olefin (COP), polycarbonate, polyester, polysulfone, polyether sulfone, polystyrene, polyolefin, polyvinyl alcohol, cellulose acetate, polymethyl methacrylate, polyvinyl chloride, polyacrylate, polyamide polymer or the like.

The liquid crystal coating layer type retardation film may be prepared by using a reactive liquid crystal composition including a nematic or smectic liquid crystal material. For example, this retardation film may be prepared by coating the reactive liquid crystal composition on a substrate, aligning the same in plane alignment, and then exposing to heat or UV rays so as to induce polymerization.

The half-wave retardation film 142 and the quarter-wave retardation film 144 emit the incident light by delaying a phase by ½ λ and ¼ λ with respect to the component vibrating in the slow axis direction, respectively. Thereby, reflection of light incident from the outside of the display device may be effectively suppressed.

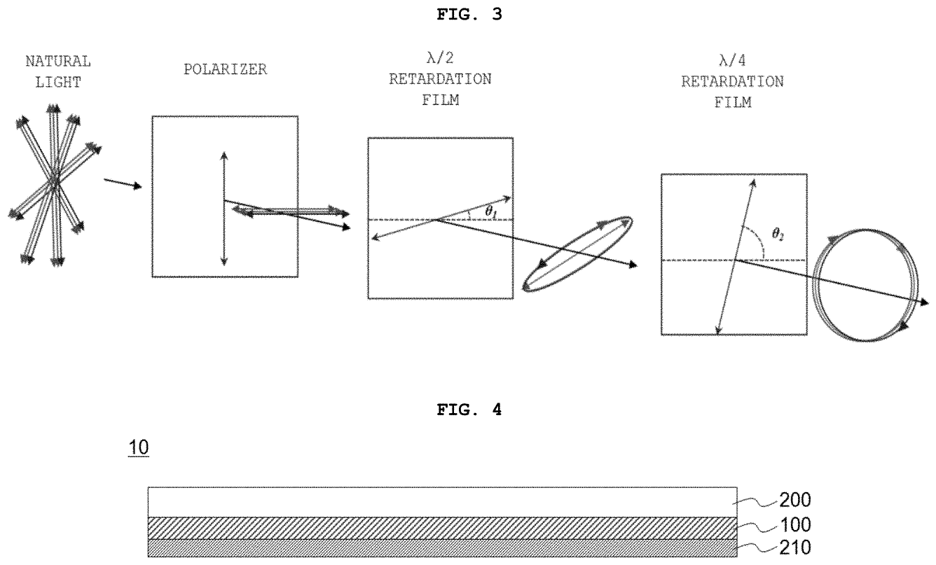

FIG. 3 is a schematic view illustrating a traveling pattern of light passing through a polarizing laminate according to exemplary embodiments.

Referring to FIG. 3, the slow axis of the half-wave retardation film 142 may form a first angle θ₁ with the absorption axis of the polarizer 120. The slow axis of the quarter-wave retardation film 144 may form a second angle θ₂ with the absorption axis of the polarizer 120.

As a non-limiting example, the first angle θ₁ may be substantially 15°, and the second angle θ₂ may be substantially 75°. Herein, the term “substantially 15° and 75°” may mean that the first and second angles are allowed to be about ±5° based on the respective angles. In this case, the polarized light passing through the half-wave retardation film 142 may be converted into elliptically polarized light, and the elliptically polarized light may pass through the quarter-wave retardation film 144 to be substantially converted into circularly polarized light.

The first angle θ₁ and the second angle θ₂ are not limited thereto, and may be provided as an angle at which linearly polarized light passing through the half-wave retardation film 142 and the quarter-wave retardation film 144 is to be circularly polarized light.

When using the half-wave retardation film 142 and the quarter-wave retardation film 144 together, a phase retardation effect is substantially implemented over an entire visible light region, such that it is possible to achieve an image display device with significantly improved phenomena such as light leakage.

In some embodiments, the half-wave retardation film 142 and the quarter-wave retardation film 144 may be adhered with each other through an adhesive layer 146. The adhesive layer may be formed of a photocurable adhesive.

According to embodiments of the present invention, a polarizing laminate 100 having an entire thickness of 30 to 40 μm may be formed while securing antireflection characteristics and excellent mechanical strength. In this case, flexibility of the entire polarizing laminate 100 may be further increased, and suitability for a flexible image display device may be improved.

In some embodiments, the polarizing laminate 100 may include an additional protective film on a side of the protective layer 110 opposite to the retardation layer 140 side, as well as a pressure-sensitive adhesive layer and a release film on a side of the retardation layer 140 opposite to the polarizer 120 side. The additional protective film and the release film may protect the polarizing laminate 100 during distribution, and may be removed when applying the polarizing laminate 100 to the display device.

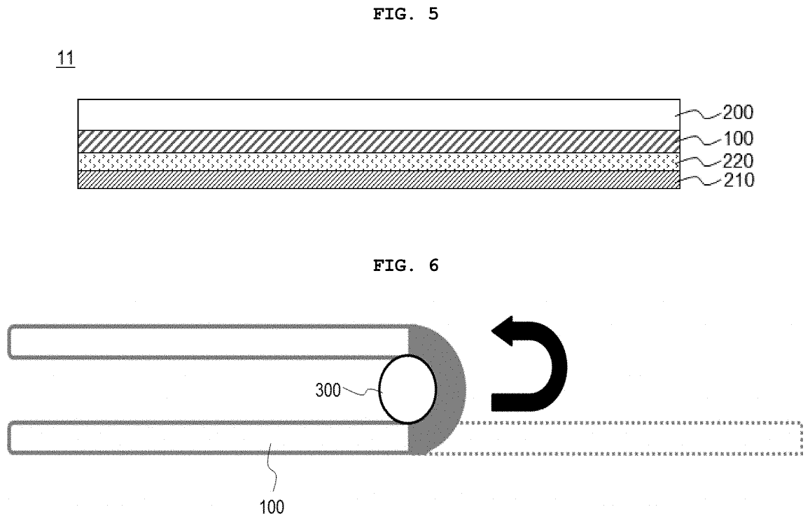

FIGS. 4 and 5 are schematic cross-sectional views illustrating image display devices according to embodiments.

Referring to FIG. 4, an image display device 10 may include the polarizing laminate 100, a window substrate 200, and a display panel 210.

In this disclosure, when using the polarizing laminate 100 in the image display device, a “visible side” refers to a surface adjacent to a direction viewed by a user. For example, a side opposite to the visible side may face the display panel of the image display device. Hereinafter, the side opposite to the visible side is referred to as a “panel side.”

The window substrate 200 may include a soluble resin material such as glass or polyimide, and may include a hard coating layer on at least one surface thereof. The window substrate 200 may be disposed on the visible side of the image display device 10.

The polarizing laminate 100 may be disposed so that the protective layer 110 faces the visible side or the window substrate 200. The retardation layer 140 of the polarizing laminate 100 may be disposed on the display panel 210 side. For example, the release film of the polarizing laminate 100 may be removed, and the display panel 210 may be adhered thereto through the pressure-sensitive adhesive layer.

Referring to FIG. 5, an image display device 11 may include a touch sensor 220 disposed on one surface of the polarizing laminate 100. In an aspect of suppressing reflection of external light due to the touch sensor 220, it is preferable that the touch sensor 220 is located on the display panel 210 side of the polarizing laminate.

According to exemplary embodiments, the display panel 210 may include an organic light emitting diode (OLED) element.

The display panel 210 may include a pixel electrode, a pixel defining film, a display layer, a counter electrode, and an encapsulation layer, which are disposed on a panel substrate.

The panel substrate may include a soluble resin material such as glass or polyimide. A pixel circuit including a thin film transistor (TFT) may be formed on the panel substrate, and an insulation film may be formed to cover the pixel circuit. The pixel electrode may be electrically connected with a drain electrode of the TFT on the insulation film, for example.

The pixel defining film may be formed on the insulation film to expose the pixel electrode, thus to define a pixel region. The display layer is formed on the pixel electrode, and the display layer may include, for example, an organic light emitting layer.

The counter electrode may be disposed on the pixel defining film and the display layer. The counter electrode may be provided, for example, as a common electrode or a cathode of the image display device. The encapsulation layer for protecting the display panel may be laminated on the counter electrode.

The image display device including the polarizing laminate according to exemplary embodiments may be the flexible image display device.

The polarizing laminate 100 according to exemplary embodiments may be provided as an antireflective polarizing plate of an OLED display device. The OLED display device may be a flexible display device that can be bent in at least one direction.

Hereinafter, preferred examples are proposed to more concretely describe the present invention. However, the following examples are only given for illustrating the present invention and those skilled in the art will obviously understand that various alterations and modifications are possible within the scope and spirit of the present invention. Such alterations and modifications are duly included in the appended claims.

### Preparative Example: Preparation of Protective Layer

### Preparative Example 1

Pellets of ZEONOR 1420 (manufactured by Nihon Xeon Co., Ltd.) as a norbornene resin were dried at 100° C. for 5 hours.

The pellets were fed into an extruder, melted in the extruder, then passed through a polymer pipe and a polymer filter, followed by extruding in a sheet shape from a T-die onto a casting drum and cooling to obtain a non-elongated film having a thickness of 40 μm.

The non-elongated film was continuously supplied to a tenter drawing machine, and subjected to first elongation at a feeding angle of 45°, a drawing temperature of 140° C., and a drawing ratio of 1.3 times to obtain a first elongated film oriented at an inclination of an average angle of 45° with respect to a winding direction, followed by winding on a winding core.

The first elongated film was turned over, and supplied to the tenter drawing machine so as to be oriented in a direction of 90° with respect to an orientation angle of the first elongated film, and subjected to second elongation at a feeding angle of 45°, a drawing temperature of 145° C., and a drawing ratio of 2.0 times. Then, 150 mm of both ends of the elongated film were trimmed to obtain a second elongated film having a width of 1340 mm. The obtained long second elongated film was uniform in the width direction. The second elongated film is an oblique elongated film having a thickness of 18 μm, and detailed properties thereof are shown in Table 1 below.

### Preparative Example 2

Pellets of ZEONOR 1420 (manufactured by Nihon Xeon Co., Ltd.) as a norbornene resin were dried at 100° C. for 5 hours.

The pellets were fed into an extruder, melted in the extruder, then passed through a polymer pipe and a polymer filter, followed by extruding in a sheet shape from a T-die onto a casting drum and cooling to obtain a non-elongated film having a thickness of 13 μm. Detailed properties of the film are shown in Table 1 below.

### Preparative Example 3

All procedures described in Preparative Example 1 were equally performed, except that the drawing ratio was changed to 1.5 times. The obtained second elongated film was an oblique elongated film having a thickness of 22 μm, and detailed properties thereof are shown in Table 1 below.

### Preparative Example 4

Pellets of ZEONOR 1420 (manufactured by Nihon Xeon Co., Ltd.) as a norbornene resin were dried at 100° C. for 5 hours.

The pellets were fed into an extruder, melted in the extruder, then passed through a polymer pipe and a polymer filter, followed by extruding in a sheet shape from a T-die onto a casting drum and cooling to obtain a non-elongated film having a thickness of 25 μm. Detailed properties of the film are shown in Table 1 below.

### Example: Preparation of Polarizing Laminate

A transparent non-elongated polyvinyl alcohol film (PE20, Kuraray Co.) having a saponification degree of 99.9% or more was immersed in water (deionized water) at 30° C. for 2 minutes to swell the same. Then, the film was immersed in a dyeing solution containing 1.25 mM/L of iodine, 1.25 wt. % of potassium iodide and 0.0005 wt. % of nitric acid at 30° C. for 4 minutes. Specifically, in the swelling and dyeing steps, the film was elongated at a drawing ratio of 1.3 times and 1.4 times, respectively, so as to reach a cumulative drawing ratio of 1.82 times.

Subsequently, the elongated film was immersed in a cross-linking solution containing 10 wt. % of potassium iodide and 3.7 wt. % of boric acid at 50° C. for 30 seconds, and elongated at a drawing ratio of 2 times while cross-linking the same (first cross-linking). Thereafter, the treated film was immersed in an aqueous solution for cross-linking containing 10 wt. % of potassium iodide and 3.7 wt. % of boric acid at 50° C. for 20 seconds, and elongated at a drawing ratio of 1.5 times while cross-linking the same (second cross-linking) (cumulative drawing ratio of the first and second cross-linking was 3 times). During the swelling/dying/cross-liking processes, the treated film was elongated to reach a cumulative drawing ratio of 5.46 times. The cross-linked polyvinyl alcohol film was dried in an oven at 70° C. for 4 minutes to prepare a polarizer having a thickness of 8 μm.

A half-wave retardation film (Fujifilm, λ/2 plate described in Example 4 of Korean Patent Laid-Open Publication No. 10-2014-0135739, material DLC) and a quarter-wave retardation film (Fujifilm, λ/4 plate described in Example 4 of Korean Patent Laid-Open Publication No. 10-2014-0135739, material RLC) were sequentially attached to one surface of the prepared polarizer using an adhesive. An entire thickness of the half-wave retardation film and the quarter-wave retardation film including the adhesive was 7 μm.

A polarizing laminate was prepared by attaching a cyclic polyolefin resin film (Zeonor, Zeon Co.) prepared according to the preparative examples as a protective layer to the other surface of the polarizer. The protective layer has characteristics listed in Table 1 below.

The coefficient of thermal expansion of the protective layer was measured by TMA (Thermomechanical Analyzer, TA Instrument Co.), and the breaking strength and storage modulus were measured by AG-I of Shimadzu Co.

TABLE 1

| | | | | Breaking | | Storage | | |
|---|---|---|---|---|---|---|---|---|
| | | | Coefficient | strength | | modulus | | |
| | | Whether | of thermal | (N/25 nm) | | (MPa) | | UV |
| | Thickness | or not | expansion | Direction | | Direction | | transmittance |
| Section | (μm) | elongated | (60 μm/m ° C.) | MD | TD | MD | TD | (%; @380 nm) |
| Preparative | 18 | Obliquely | 58.4 | 26 | 23 | 1,930 | 2,040 | 1 |
| Example 1 | | elongated | | | | | | |
| Preparative | 13 | Non-elongated | 69.7 | 17 | 18 | 1,940 | 1,900 | 90.6 |
| Example 2 | | | | | | | | |
| Preparative | 22 | Obliquely | 82.5 | 36 | 36 | 2,100 | 2,000 | 0.4 |
| Example 3 | | | | | | | | |
| Preparative | 25 | Non-elongated | 87.6 | 32 | 33 | 2,020 | 1,960 | 3.3 |
| Example 4 | | | | | | | | |

### Experimental Example: Evaluation of Folding Properties

Using a dynamic cyclic folding tester (Covotech Co.) for the polarizing laminates of the examples and comparative examples, as shown in FIG. 6, the polarizing laminate 100 was repeatedly bent 200,000 times so that the protective layers face each other along a folding jig 300 having a diameter of 1.5 mm.

The above-described bending test was performed under conditions of −20° C., 25° C., and 60° C. (95% RH), respectively, and folding properties were evaluated in such a way that, if a crack or peeling-off occurred in a bent portion, it was determined as NG, otherwise, it was determined as OK. Results thereof are shown in Table 2 below.

TABLE 2

| | | Entire | Folding properties | | |
|---|---|---|---|---|---|
| | | thickness | (@1.5 R | | |
| | | of | bending 20 times) | | |
| | | polarizing | | | 60° C., |
| | Protective | laminate | | | 95% |
| Section | layer | (μm) | −20° C. | 25° C. | RH |
| Example | Preparative | 36 | OK | OK | OK |
| | Example 1 | | | | |
| Comparative | Preparative | 31 | NG | NG | OK |
| Example 1 | Example 2 | | | | |
| Comparative | Preparative | 40 | NG | NG | NG |
| Example 2 | Example 3 | | | | |
| Comparative | Preparative | 43 | NG | NG | NG |
| Example 3 | Example 4 | | | | |

Referring to Table 2, it was confirmed that the polarizing laminate of the examples was prevented from being cracked and peeled-off during folding under conditions of low temperature, room temperature, and high temperature and high humidity compared to the polarizing laminate of the comparative examples.

What is claimed is:

1. A polarizing laminate comprising:
a polarizer having a first surface and a second surface opposite to the first surface;
a retardation layer disposed on the first surface of the polarizer; and
a protective layer disposed on the second surface of the polarizer, the protective layer having a coefficient of thermal expansion of 60 μm/m·° C. or less.

2. The polarizing laminate according to claim 1, wherein the retardation layer comprises a quarter-wave retardation film.

3. The polarizing laminate according to claim 1, wherein the protective layer has a thickness of 10 to 20 μm.

4. The polarizing laminate according to claim 1, wherein the polarizing laminate has a thickness of 30 to 40 μm.

5. The polarizing laminate according to claim 1, wherein the protective layer has a coefficient of thermal expansion of 40 μm/m·° C. to 60 μm/m·° C.

6. The polarizing laminate according to claim 1, wherein the protective layer has a near-ultraviolet transmittance of 3% or less.

7. The polarizing laminate according to claim 1, wherein the protective layer has a breaking strength of 20 to 30 N/25 mm.

8. The polarizing laminate according to claim 1, wherein the protective layer has a storage modulus of 1,900 to 2,100 MPa.

9. An image display device comprising the polarizing laminate according to claim 1.

10. The image display device according to claim 9, wherein the image display device is a flexible image display device.

11. The image display device according to claim 10, further comprising a window substrate, a touch sensor, and a display panel.
